(19) United States
(12) Patent Application Publication
(10) Pub. No.: US 2009/0315638 A1
(43) Pub. Date: Dec. 24, 2009

(54) MILLIMETER WAVE LOW-LOSS HIGH-ISOLATION SWITCH

(75) Inventors: Yi-Chi Shih, Palos Verdes Estates, CA (US); Kiet Mai, Pasadena, CA (US); Long Bui, Palos Verdes Estates, CA (US)

Correspondence Address: HONEYWELL/BLG;Patent Services, 101 Columbia Road, PO Box 2245, Morristown, NJ, 07962-2245, US

(73) Assignee: Honeywell International Inc., Morristown, NJ (US)

(21) Appl. No.: 12/145,271

(22) Filed: Jun. 24, 2008

(51) Int. Cl. H01P 1/10

(52) U.S. Cl. 333/106; 333/258

(57) ABSTRACT

A switch for selectively providing an input signal to an output terminal. The switch includes a first waveguide terminal, a second waveguide terminal, a reduced-width waveguide connecting the first waveguide terminal to the second waveguide terminal, and at least one switching element spanning the reduced-width waveguide between the first and second waveguide terminals. The reduced-width waveguide is configured to pass a signal from the first waveguide terminal to the second waveguide terminal when the at least one switching element is in a first state and block a signal when the at least one switching element is in a second state. In some embodiments, the switch also includes at least one additional waveguide terminal and the reduced-width waveguide also connects the first waveguide terminal to the at least one additional waveguide terminal.

### BACKGROUND OF THE INVENTION

Many millimeter wave radar sensor and communications systems use high-speed, high-isolation switches to enable fast response performance. However, high isolation solid-state switches typically have high insertion loss that degrades transmitter output power and receiver sensitivity. Accordingly, there is a need for an improved high isolation switch having low insertion loss.

### SUMMARY OF THE INVENTION

The present invention includes a switch for selectively providing an input signal to an output terminal. The switch includes a first waveguide terminal, a second waveguide terminal, a reduced-width waveguide connecting the first waveguide terminal to the second waveguide terminal, and at least one switching element spanning the reduced-width waveguide between the first and second waveguide terminals. The reduced-width waveguide is configured to pass a signal from the first waveguide terminal to the second waveguide terminal when the at least one switching element is in a first state and is configured to block a signal from the first waveguide terminal to the second waveguide terminal when the at least one switching element is in a second state.

In accordance with further aspects of the invention, the switching elements are diodes, the first state includes a reverse bias, and the second state includes a forward bias.

In accordance with other aspects of the invention, the reduced width waveguide includes a taper from a width of the first and second terminals to a reduced width section.

In accordance with still further aspects of the invention, the reduced-width waveguide includes a substrate, a first conductive region, and a second conductive region. A reduced width region exists between the first and second conductive regions, the switching elements span the reduced width region, and the switching elements are connected to the first conductive region and the second conductive region.

In accordance with yet other aspects of the invention, the first and second waveguide terminals are formed in a block and the reduced-width waveguide is situated in a groove formed in the block between the first and second waveguide terminals.

In accordance with still another aspect of the invention, the switch includes a split block housing having a first section and a second section. The reduced-width waveguide is situated between the first and second sections of the split block housing.

In accordance with still further aspects of the invention, the switch includes at least one additional waveguide terminal and the reduced-width waveguide also connects the first waveguide terminal to the at least one additional waveguide terminal. At least one switching element spans the reduced width waveguide between the first waveguide terminal and the at least one additional waveguide terminals.

### BRIEF DESCRIPTION OF THE DRAWINGS

Preferred and alternative embodiments of the present invention are described in detail below with reference to the following drawings:

FIG. 1 is an x-ray perspective diagram of a switch formed in accordance with an embodiment of the invention;

FIG. 2 is a diagram showing a substrate with mounted diodes used in the reduced-width waveguide of the switch shown in FIG. 1;

FIG. 3 is diagram showing an x-ray perspective view of a top section of a three terminal switch formed in accordance with an embodiment of the invention;

FIG. 4 is a diagram showing a perspective view of a corresponding bottom section and reduced-width waveguide for the top section of the switch shown in FIG. 3;

FIG. 5 is a diagram showing a perspective view of the reduced-width waveguide shown in FIG. 4; and

FIG. 6 is a diagram showing the top section, bottom section, and reduced-width waveguide of the switch shown in FIGS. 4 and 5 assembled together.

### DETAILED DESCRIPTION OF THE INVENTION

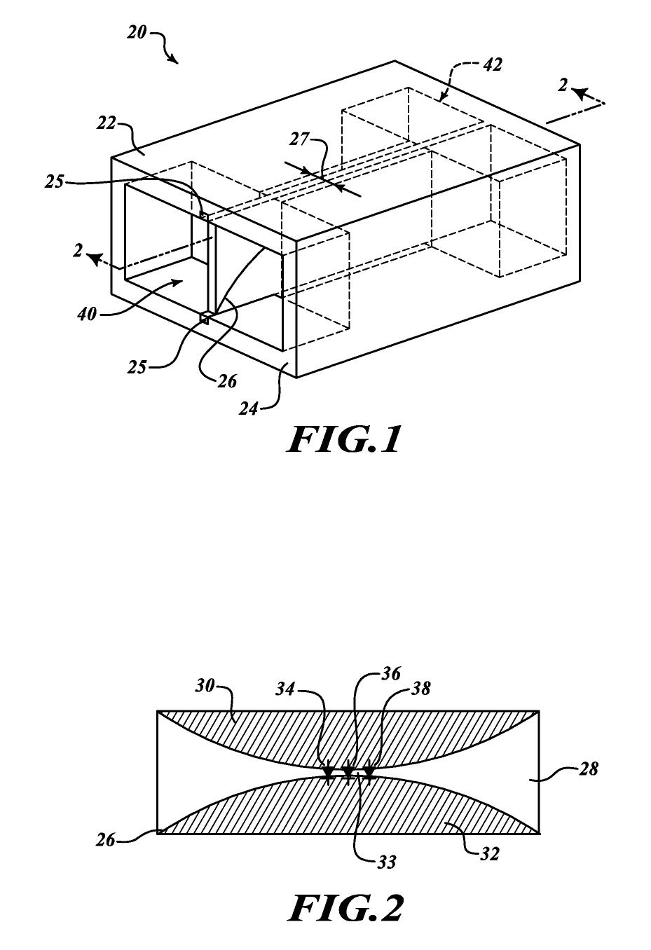

FIGS. 1 and 2 are diagrams of a single pole, single throw (SPST) switch 20 formed in accordance with an embodiment of the invention. In an example embodiment, the switch 20 includes a block that has a first portion 22, a second portion 24, and a pair of grooves 25 between the first portion 22 and the second portion 24. A reduced-width waveguide 26 is disposed between the first and second portions 22, 24 in the grooves 25. In a central region of the switch 20, the first and second portions 22, 24 include inner walls that are spaced apart at a distance 27 that is typically between approximately 25 mils (0.635 millimeters) and 220 mils (5.588 millimeters) wide, depending on the operating frequency range of the switch 20. The first and second portions 22, 24 of the switch 20 define a first waveguide terminal 40 at a first end of the switch 20 and a second waveguide terminal 42 at a second end of the switch 20. The switch 20 may be used in a variety of applications, such as to selectively allow an input signal from a transmitter (not shown) at the first waveguide terminal 40 to be passed to an antenna (not shown) at the second waveguide terminal 42 that is being used as an output terminal in this example. The switch 20 may be used in millimeter wave pulse radar or time-division multiplexing (TDM) communications systems, for example.

In an example embodiment, the first and second waveguide terminals 40, 42 have a typical size and structure for use with millimeter wave signals, and the first and second portions 22, 24 of the switch 20 are formed of a single block of aluminum. The first and second waveguide terminals 40, 42 may include standard dimensions for Ka, U, V or W bands as described by the Electronics Industry Alliance (EIA), for example. However, the first and second waveguide terminals 40, 42 may also use interface sizing for other bands or use custom dimensions in some example embodiments. In other example embodiments, the switch 20 may include a split-block housing rather than first and second portions 22, 24 formed of a single block of aluminum. The split-block housing may include separate first and second sections that are assembled in a typical manner, such as by using screws (not shown), for example, with the reduced width waveguide 26 disposed between the first and second sections.

As best seen in FIG. 2, the reduced-width waveguide 26 includes a substrate 28 that is preferably a dielectric substrate. The substrate 28 is typically between approximately 5 mils (0.127 millimeters) and approximately 20 mils (0.508 millimeters) thick when used for millimeter wave applications. The substrate 28 may be Teflon®, Duroid®, or quartz, for example. However, other substrate types may also be used. The reduced-width waveguide 26 also includes a finline taper transition portion that is formed of a first conductive region 30 and a second conductive region 32. The first and second conductive regions 30, 32 may be printed metal patterns on the substrate 28, such as a copper or gold plated copper metal pattern, for example. The first and second conductive regions 30, 32 are preferably on one side of the substrate 28, but may also be included on both sides of the substrate 28. The first and second conductive regions 30, 32 define a narrow reduced width region 33 through the substrate 28 that is not covered by the first and second conductive regions 30, 32. When the reduced-width waveguide 26 is inserted into the grooves 25 of the switch 20 shown in FIG. 1, gaps are preferably present between the substrate 28 and the inner walls of the first and second portions 22, 24 in the central region having distance 27 between the walls. The width of the gaps between the substrate 28 and the inner walls typically ranges from approximately 10 mils (0.254 millimeters) to approximately 100 mils (2.54 millimeters) wide depending on the desired operating frequency range of the switch 20. Some hidden lines are not shown for clarity.

In an example embodiment, the first and second conductive regions 30, 32 define a region that tapers from the width of the first and second terminals 40, 42 to the width of the reduced width region 33, with the taper generally following a curve derived from a cosine function. However, in other embodiments other taper profiles, such as a linear taper may be used. Different widths may be used for the reduced width region 33. In one example embodiment, the reduced width region 33 is preferably between approximately 5 thousandths of an inch (mils) and approximately 10 mils wide at its narrowest point. This is equivalent to approximately 0.127 millimeters (mm) to approximately 0.254 mm. Generally, the reduced width region 33 is reduced in width by at least a factor of 8 as compared to the first and second terminals 40, 42. However, other width reduction factors may be used depending on desired isolation level for the switch 20.

The reduced width region 33 is spanned by at least one switching element that is connected to the first conductive region 30 and the second conductive region 32. In the example embodiment shown, a first diode 34, a second diode 36, and a third diode 38 are used as the switching elements. In an example embodiment, the diodes 34, 36, and 38 are beam lead positive intrinsic negative (PIN) diodes. However, other types of diodes such as mesa diodes may also be used. The diodes are attached in a typical manner, such as by soldering, wire bonding, or by using silver epoxy, for example. Although three diodes are shown in this example embodiment, other numbers of diodes or other types of switching elements may be used. Preferably, at least two and no more than four diodes are used with a spacing distance between each diode of approximately ¼ of a wavelength of a predetermined signal to be switched. However, other spacing distances may also be used. The reduced width region 33 of the reduced width waveguide 26 in combination with the limited number of switching elements allows the switch 20 to achieve high isolation low insertion loss performance. A performance of isolation as high as approximately 40 to 60 dB and an insertion loss as low as approximately 0.2 to 0.5 dB can be achieved using three diodes in some embodiments. Generally, high isolation is achieved because the reduced-width waveguide section of the switch 20 can suppress penetration of electromagnetic fields so that leakage is significantly lower compared to a regular-sized waveguide. With the reduced-width waveguide, a small number of diodes may be used to achieve the required isolation which results in low insertion loss.

The reduced-width waveguide 26 extends from the first waveguide terminal 40 to the second waveguide terminal 42. The diodes 34, 36, and 38 span the reduced width waveguide 26 between the first waveguide terminal 40 and the second waveguide terminal 42. The reduced-width waveguide 26 connects the first waveguide terminal 40 to the second waveguide terminal 42. The reduced-width waveguide 26 is configured to pass a signal from the first waveguide terminal 40 to the second waveguide terminal 42 when the diodes 34, 36, and 38 are in a reverse biased state and to block a signal when one or more of the diodes 34, 36, and 38 are in a forward biased state. In some embodiments, variable attenuation of a signal through the reduced-width waveguide is also possible. A small amount of signal leakage through the switch 20 may also occur when the diodes 34, 36, and 38 are in a forward biased state, given that the switch 20 has a finite isolation. In the example shown in FIG. 2, the diodes 34, 36, and 38 are oriented such that their cathodes are connected to the second conductive region 32 and their anodes are connected to the first conductive region 30. In an example embodiment, the diodes 34, 36, and 38 are switched from a reverse biased to a forward biased state by applying either a negative or a positive control voltage respectively to the first conductive region 30, with the second conductive region 32 being connected to ground. In an example embodiment, the first conductive region 30 makes contact with the switch housing, such as the second portion 24, when the waveguide 26 is inserted into the grooves 25. The switch housing may also be connected to ground in some embodiments. The second conductive region 32 is covered with a thin insulating tape, such as Mylar tape, for example to insulate the second conductive region 32 from the switch housing. The insulating tape is approximately 1 mil (0.0254 millimeters) thick in some embodiments. In some examples, the second conductive region 32 is also connected to a control circuit (not shown) so that a DC control voltage can be applied. Typical control voltages are ±3V, 5V, 12V, or 15V depending on the control circuit used and the power handling requirements of the switch 20. However, other control voltages may be used. In other embodiments, the diodes 34, 36, and 38 may be oriented in a reverse fashion, with correspondingly reversed voltage polarities required to forward or reverse bias the diodes. A control circuit (not shown) or other systems (not shown) may be used to apply the control voltage to the diodes 34, 36, and 38.

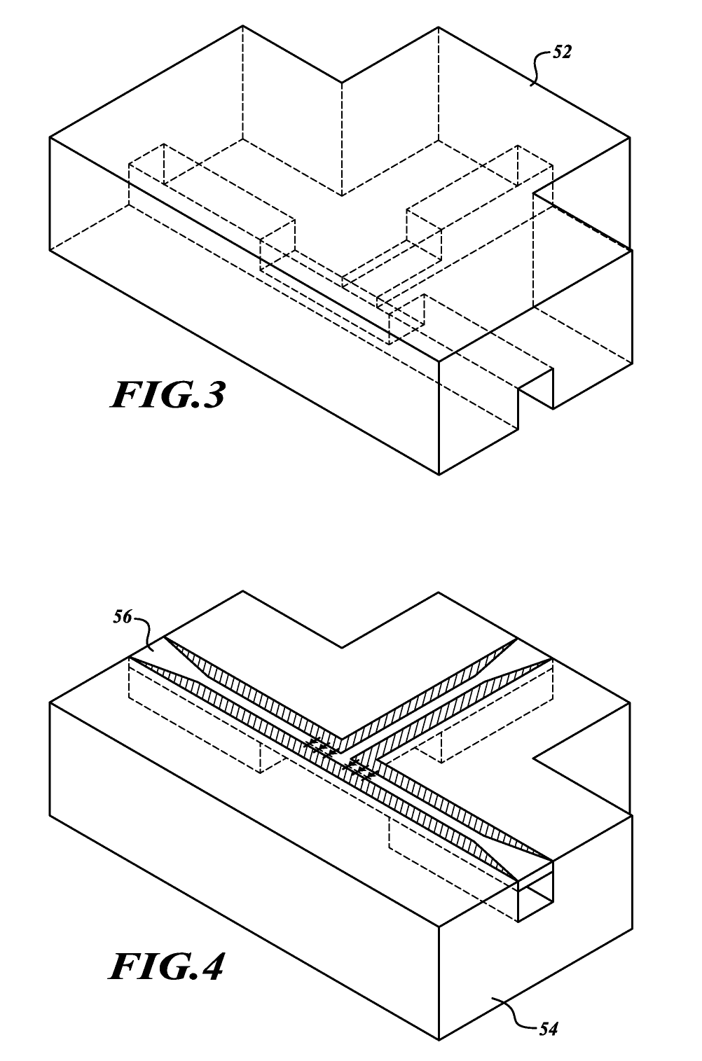

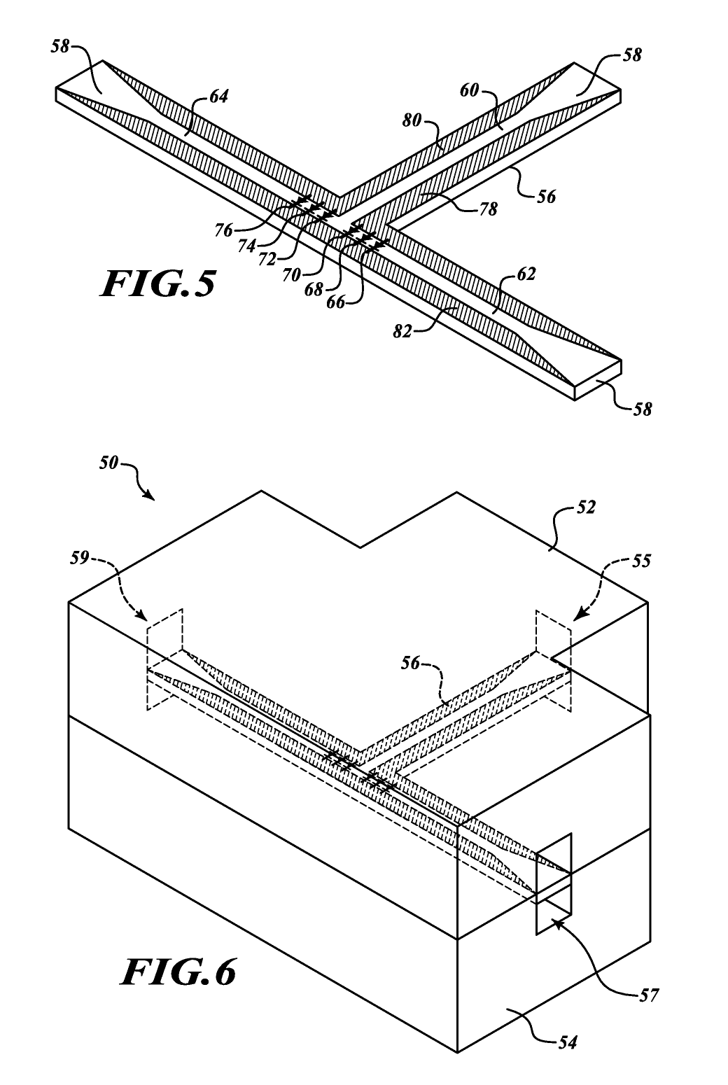

FIGS. 3-6 show diagrams of a three terminal single pole, double throw (SPDT) switch 50 formed in accordance with an embodiment of the invention. FIG. 3 is diagram showing an x-ray perspective view of a top section 52 of the switch 50. FIG. 4 is a diagram showing a perspective view of a corresponding bottom section 54 for the top section 52 of the switch 50 shown in FIG. 3. FIG. 4 also shows a reduced-width waveguide 56 on the bottom section 54. FIG. 5 is a diagram showing a perspective view of the reduced-width waveguide 56 shown in FIG. 4. FIG. 6 is a diagram showing the top section 52, bottom section 54, and reduced-width waveguide 56 of the switch 50 shown in FIGS. 3 and 4 assembled together. As best seen in FIG. 6, the top section 52 and bottom section 54 define a first waveguide terminal 55, a second waveguide terminal 57, and a third waveguide terminal 59 when assembled. In an example embodiment, the first waveguide terminal 55 accepts an input signal. The switch 50 is used to direct the input signal to an output terminal at either the second waveguide terminal 57 or the third waveguide terminal 59. Not all hidden lines are shown in FIG. 6 for clarity.

As best seen in FIG. 5, the reduced-width waveguide 56 includes a substrate 58 similar to the substrate 28 shown in FIG. 2. The reduced-width waveguide 56 also includes finline taper transition portions that include a first reduced width region 60, a second reduced width region 62, and a third reduced width region 64. The finline taper transitions generally follow linear taper profiles that taper from the width of the first, second, and third waveguide terminals 55, 57, and 59 to a width of the reduced width regions 60, 62, and 64 respectively. Although a linear taper is shown, other taper profiles such as the curve shown in FIG. 2 may also be used. The second and third reduced width regions 62, 64 are spanned by at least one switching element. In the example embodiment shown, a first diode 66, a second diode 68, and a third diode 70 span the second reduced width region 62. In similar fashion, the third reduced width region 64 is spanned by a fourth diode 72, a fifth diode 74, and a sixth diode 76. The diodes may include PIN diodes, mesa diodes, or other diode types and are connected in a typical manner as discussed with respect to FIG. 2. As described with respect to FIG. 2, preferably a group of at least two and no more than four diodes are used to span each of the second and third reduced width regions 62, 64 with a spacing between the diodes in each group being approximately ¼ of a wavelength of a predetermined signal to be switched. In an example embodiment, the second and third reduced width regions 62, 64 are between approximately 5 mils and 10 mils wide at their narrowest points.

A first conductive region 78 extends along a first side of the first reduced width region 60 and a first side of the second reduced width region 62. A second conductive region 80 extends along a second side of the first reduced width region 60 and a first side of the third reduced width region 64. A third conductive region 82 extends along a second side of the second reduced width region 62 and a second side of the third reduced width region 64. The conductive regions 78, 80, and 82 are formed in a similar fashion to that described with respect to the conductive regions 30, 32 of FIG. 2.

In the example embodiment shown in FIG. 5, the first, second, and third diodes 66, 68, and 70 are oriented such that their cathodes are connected to the third conductive region 82 and their anodes are connected to the first conductive region 78. The fourth, fifth, and sixth diodes 72, 74, 76, and 78 are oriented such that their cathodes are connected to the third conductive region 82 and their anodes are connected to the second conductive region 80. In an example embodiment, the third conductive region is connected to ground, a first control voltage is applied to the first conductive region 78, and a second control voltage is applied to the second conductive region 80. Application of a positive first control voltage and a negative second control voltage forward biases the first, second, and third diodes 66, 68, and 70 while reverse biasing the fourth, fifth, and sixth diodes 72, 75, and 76. This allows an input signal to pass from the first waveguide terminal 55 to the third waveguide terminal 59 while blocking the input signal from passing to the second waveguide terminal 57. In similar fashion, reversing polarity of the control signals allows the input signal to pass from the first waveguide terminal 55 to the second waveguide terminal 57 while blocking the input signal from passing to the third waveguide terminal 59. Applying a positive voltage to both the first and second conductive regions 78, 80 blocks the input signal from passing from the first waveguide terminal 55 to either the second waveguide terminal 57 or the third waveguide terminal 59. Applying a negative control voltage to both the first and second conductive regions 78, 80 would allow the input signal to be split into two outputs with half power each. However, in most embodiments, signal splitting is not intended, with the switch 50 typically being used as a SPDT switch rather than a signal splitter.

In another example embodiment, the first, second, and third diodes 66, 68, and 70 are oriented as described above with their cathodes connected to the third conductive region 82. However, the fourth, fifth, and sixth diodes 72, 74, and 76 are oriented such that their anodes are connected to the third conductive region 82 and their cathodes are connected to the second conductive region 80. The first and second conductive regions 78, 80 are connected to ground in this example, with a single control voltage applied to the third conductive region 82. Application of a positive control voltage reverse biases the first, second, and third diodes 66, 68, and 70 and forward biases the fourth, fifth, and sixth diodes 72, 74, and 76. This allows an input signal to pass from the first waveguide terminal 55 to the second waveguide terminal 57 while blocking the signal from passing to the third waveguide terminal 59. Application of a negative control voltage forward biases the first, second, and third diodes 66, 68, and 70 and reverse biases the fourth, fifth, and sixth diodes 72, 74, and 76. This allows the input signal to pass from the first waveguide terminal 55 to the third waveguide terminal 59 while blocking the signal from passing to the second waveguide terminal 57. A control circuit (not shown) or other systems (not shown) may be used to apply the control voltage to the diodes 66, 68, 70, 72, 74, and 76.

While the preferred embodiment of the invention has been illustrated and described, as noted above, many changes can be made without departing from the spirit and scope of the invention. For example, the reduced-width waveguide may be formed using different substrate materials or different conductive materials. The first, second, and any additional waveguides may also be formed using other materials or in other configurations, such as with non-rectangular openings. Single pole, multiple throw (SPMT) and other types of switches may also be formed in accordance with the principles of the invention in addition to SPST and SPDT switches. Accordingly, the scope of the invention is not limited by the disclosure of the preferred embodiment. Instead, the invention should be determined entirely by reference to the claims that follow.

1. A switch for selectively providing an input signal to an output terminal, the switch comprising:
a first waveguide terminal;
a second waveguide terminal;
a reduced-width waveguide connecting the first waveguide terminal to the second waveguide terminal; and
at least one switching element spanning the reduced-width waveguide between the first and second waveguide terminals, wherein
the reduced-width waveguide is configured to pass a signal from the first waveguide terminal to the second waveguide terminal when the at least one switching element is in a first state and is configured to block a signal from the first waveguide terminal to the second waveguide terminal when the at least switching element is in a second state.

2. The switch of claim 1, wherein the at least one switching element is a diode, the first state includes a reverse bias, and the second state includes a forward bias.

3. The switch of claim 1, wherein the reduced-width waveguide is reduced in width by at least a factor of eight as compared to the first and second waveguide terminals.

4. The switch of claim 1, wherein the reduced-width waveguide includes a taper from a width of the first and second terminals to a reduced width section.

5. The switch of claim 4, wherein the taper generally follows a curve derived from a cosine function.

6. The switch of claim 4, wherein the taper is a linear taper.

7. The switch of claim 1, wherein the reduced-width waveguide comprises:
a substrate;
a first conductive region; and
a second conductive region,
wherein a reduced width region exists between the first and second conductive regions, and wherein the switching elements span the reduced width region and are connected to the first conductive region and the second conductive region.

8. The switch of claim 7, wherein the first and second conductive regions include a printed metal pattern on the substrate.

9. The switch of claim 7, wherein the reduced width region is between 5 and 10 mils wide at its narrowest point.

10. The switch of claim 1, wherein the switching elements include at least two, and no more than four diodes.

11. The switch of claim 10, wherein a spacing between each of the diodes is approximately ¼ of a wavelength for a predetermined signal.

12. The switch of claim 10, wherein the diodes include PIN diodes.

13. The switch of claim 10, wherein the diodes include mesa diodes.

14. The switch of claim 1, wherein the first and second waveguide terminals are formed in a block and wherein the reduced-width waveguide is situated in a groove formed in the block between the first and second waveguide terminals.

15. The switch of claim 1, wherein the switch includes a split block housing having a first section and a second section, wherein the reduced-width waveguide is situated between the first and second sections of the split block housing.

16. The switch of claim 1, further comprising:
at least one additional waveguide terminal,
wherein the reduced-width waveguide also connects the first waveguide terminal to the at least one additional waveguide terminal and wherein at least one switching element spans the reduced width waveguide between the first waveguide terminal and the at least one additional waveguide terminals.

17. The switch of claim 16, wherein the at least one switching element spanning the reduced width waveguide between the first waveguide terminal and the at least one additional waveguide terminal is a diode.

18. The switch of claim 16, wherein the at least one additional waveguide terminal is a third waveguide terminal.

19. A method of selectively switching an input signal to an output terminal, the method comprising:
receiving an input signal at a first waveguide terminal; and
selectively applying a control signal to a switching element that spans a reduced-width waveguide that connects the first waveguide terminal to a second waveguide terminal that serves as an output terminal.

20. The method of claim 19, wherein selectively applying a control signal comprises:
applying a positive control voltage to place a diode switching element in a forward biased state to block the input signal from passing to the second waveguide terminal; and
applying a negative control voltage to place the diode switching element in a reverse biased state to allow the input signal to pass from the first waveguide terminal to the second waveguide terminal.
